(19) United States
(12) Patent Application Publication
(10) Pub. No.: US 2012/0157199 A1
(43) Pub. Date: Jun. 21, 2012

(54) Methods, Devices, Systems, Platforms, and Products for Enhancing Game Play in a Computerized Network

(75) Inventor: Jonathan Nord, Mission Viejo, CA (US)

(73) Assignee: Games i Play, Inc., San Marcos, CA (US)

(21) Appl. No.: 12/975,099

(22) Filed: Dec. 21, 2010

(51) Int. Cl. A63F 13/00

(52) U.S. Cl. 463/31

(57) ABSTRACT

Provided are methods, devices, systems, products, and platforms for updating content displayed to at least a first user of a gaming network without requiring the refreshing of the user's display page that comprises the step of updating partition content with a corresponding server content if the corresponding server content is flagged for update for that particular user.

### BACKGROUND OF THE INVENTION

Traditional board and card games, a favorite pastime of many, have been around for centuries. The arrival of the internet and the new technological age has seen the adaptation of traditional board and card games to more current technologies such that players of a game no longer are required to be within a certain physical proximity of each other to participate. For example, players may now access the internet and compete with a friend or foe in cyberspace over an interconnected network. Online games, i.e., those accessed via the internet, in particular, feature single-player action, multi-player action or even massive multi-player action that can contain tens of thousands of simultaneous gamers.

### SUMMARY OF THE INVENTION

There are several disadvantages with the current technology for multi-player game play over an interconnected network. The very nature of a networked game play creates situations where one player may become disinterested with a slow pace of game play due to the absence of any physical interaction between the players. In other situations, players may wish to play many games at any once, and would benefit from the ability of the real-time update of the current status and circumstances of the game.

Provided herein is a method, device, system, platform, and computer product for updating content displayed to a user of a gaming network without the requirement of refreshing the user's webpage. In some embodiments, partition content of a single player is updated. For example, described herein is a method, device, system, platform, and computer product for updating a content displayed to a user of a gaming network without requiring refreshing of the user's display page that comprises updating a partition content that is depicted on a display page of a user of a gaming network with a corresponding server content if the corresponding server content is flagged for update.

In further or additional embodiments, provided herein is a method, device, system, platform, and computer product for updating a content displayed simultaneously to at least a first user and a second user of a gaming network without requiring refreshing of a display page comprising the updating of a partition content that is depicted on a display page of the first user of a gaming network with a corresponding server content for the first user if the corresponding server content is flagged for update for the first user.

An aspect of the subject matter described herein is updating partition content with server content that if the corresponding server content is flagged for update for a particular player of a game in a computerized network with a single or plurality of members. In some embodiments, the subject matter described herein further comprises unflagging the server content after it is updated on a display page (e.g., a webpage) of a user, or on display pages of plural users. In further or additional embodiments, also provided is the flagging of server content for update in response to any change in the server content from, for example, a move or “play” from a player that is depicted in the player's partition content. In further or additional embodiments, server content is provided that is initiated by a user of a website, an automated function, or a combination thereof. In some embodiments, server content is flagged for a user of the website, server content is flagged for no user of the website, or a combination thereof. In further or additional embodiments, an updating function of a user's webpage is scheduled, and still further, an updating function optionally is scheduled to occur every two seconds. In further embodiments, the updating function is scheduled for a fixed period of time, but is adjustable based on a number of factors including, for example, the game type and player demands.

In some embodiments, web content appears to a player on a display device in a plurality of dynamically created windows each of which comprise a partition content. In further or additional embodiments, web content appears on a pop-up window that is opened, moved, and/or closed by a user of the website. In still further embodiments, the web content is related to an online web-based game that is selected from a card game, a board game, a casino game, a cell phone game, a dice game, an arcade game, a puzzle game, a role playing game, a tabletop game, or a video game.

### BRIEF DESCRIPTION OF THE DRAWINGS

FIG. 1 is illustrative of an online card engine for a web-based gaming network depicting an embodiment of a user's display.

FIG. 2 is illustrative of an online card engine for a web-based gaming network depicting one embodiment of a server database pulsing a user's webpage.

FIG. 3 is illustrative of an online card engine for a web-based gaming network depicting one embodiment of a user's website interacting with a server database.

FIG. 4 is illustrative of an online card engine for a web-based gaming network depicting one embodiment of a user initiating the gaming process.

### DETAILED DESCRIPTION OF THE INVENTION

Disclosed herein are computer-based gaming platforms, systems, products, devices and methods for updating a portion of a gaming display without the requirement of refreshing the entire display. In some embodiments, the computer-based gaming is intranet-based. In some embodiments, the gaming is Internet-based. In further or additional embodiments, the gaming is World Wide Web-based. In still further embodiments, the gaming is based on cloud computing. In other embodiments, the gaming is based on data storage devices including, by way of non-limiting examples, CD-ROMs, DVDs, flash memory devices, magnetic disk drives, optical disk drives, and the like.

The gaming systems, platforms, methods, products, and devices described herein comprise a digital processing device. The digital processing device includes one or more hardware central processing units (CPU) that carry out the device's functions. The digital processing device further comprises an operating system configured to perform executable instructions, a memory device, a display, an input device, and optionally a sound output device. In some embodiments, the digital processing device is connected to the Internet such that it can access the World Wide Web. In other embodiments, the digital processing device is connected to an intranet. In other embodiments, the digital processing device is connected to a data storage device.

The digital processing device includes an operating system configured to perform executable instructions. The operating system is, for example, software, including programs and data, which manages the device's hardware and provides services for execution of applications. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

The digital processing device includes a memory device. The memory is one or more physical apparatus used to store data or programs on a temporary or permanent basis. In some embodiments, the memory is volatile and requires power to maintain stored information. In some embodiments, the memory is non-volatile and can retain stored information when the digital processing device is not powered.

The digital processing device includes a display to send visual information to a gamer. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is a plasma display. In other embodiments, the display is a video projector. In still further embodiments, the display is a combination of devices such as those disclosed herein.

The digital processing device includes an input device to receive information from a gamer. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In accordance with the description herein, suitable digital processing devices include, by way of non-limiting examples, desktop computers, laptop computers, notebook computers, net book computers, set top computers, handheld computers, Internet appliances, mobile smart phones, tablet computers, and video game consoles. Those of skill in the art will recognize that many Internet connected mobile phones are suitable for use in the system described herein. Suitable tablet computers include those with booklet, slate, and convertible configurations, known to those of skill in the art.

### Online Card Engine: Dynamic Player Displays

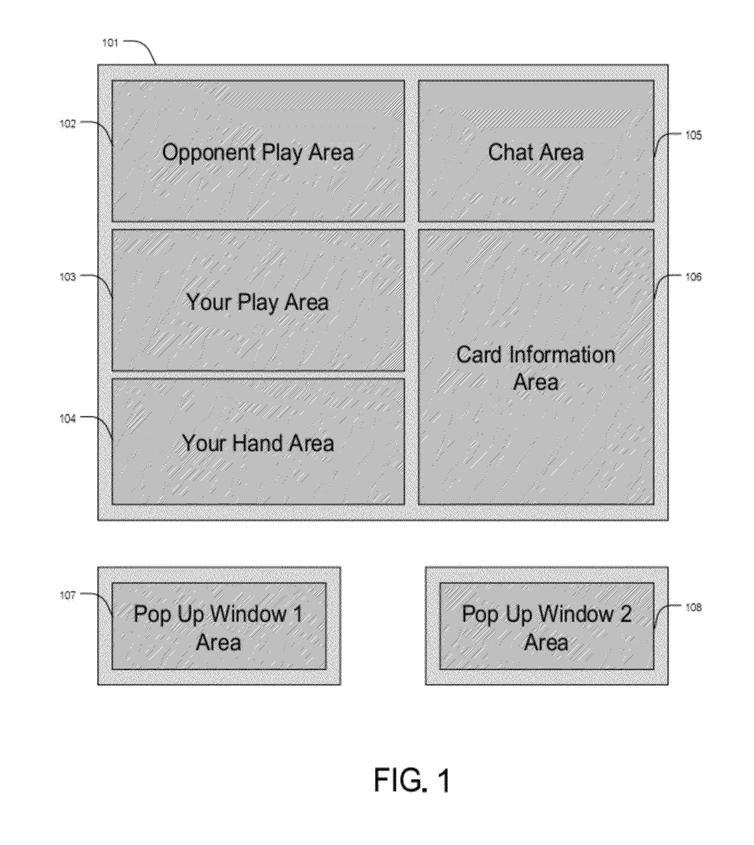

One feature of the platforms, methods, products, devices, and systems described herein is a dynamic display for a player of an online game. As used herein, “user,” “gamer,” and “player” are used interchangeably and refer to the person or entity playing an interactive game. Referring to FIG. 1, shown is a display 101 (e.g., a monitor) as one non-limiting embodiment of a user (e.g., a player) within a gaming network. The user's monitor 101 is broken up into multiple dynamic windows. A partition content, which comprises at least a portion of a dynamic window, is configured to be updated irrespective of any other window. In certain embodiments, partition content is updated without requiring the website displaying the partition content to be updated. For example, partition content within the play area of the opponent of the game 102 is configured to be updated without requiring other play areas to be updated, including as non-limiting examples a chat area 105, the user's play area 103, the user's hand of cards area 104, a card information area 106, and pop-up windows 107 and 108. In further or additional embodiments, a partition content within the user's play area 103 is configured to be updated without requiring other play areas to be updated, including as non-limiting examples the play area of the opponent of the game 102, a chat area 105, the user's hand of cards area 104, a card information area 106, and pop-up windows 107 and 108. Indeed, each dynamic window, or any portion thereof, comprises at least one partition content that is configured to be updated without requiring the updating of other windows or partition contents within the webpage. In certain embodiments, at least two windows (e.g., the user's play area 103 and the user's hand of cards area 104) are each updated simultaneously or almost simultaneously updated. Although only two players are depicted in FIG. 1, it is readily understood by a person of skill in the art that the card engines described herein support single player game play, or many player game play. For example, in some embodiments, the card engines described herein support game play for 1 to 100 players, or more than 100. In further embodiments, a dynamic window of for each player is depicted on each of the displays of the other players in the gaming network, including those playing the game. In a specific embodiment, provided is a drop down menu for an “opponent's play zone” that permits a player to cycle through to choose how many and which opponent's play area is to be displayed.

“Partition content,” as described herein, comprises data of web content, for example an element or object that appears on a web page of a user's display. In certain embodiments, partition content includes at least a portion of a webpage and is distinguished from the webpage depicting the partition content. Partition content is updated on a webpage without updating the webpage itself. For example, in a specific game play embodiment, partition content comprises text describing game play or a graphic of a game card.

“Server content,” as described herein, comprises data in a database server module that directly relates to partition content depicted on a user's display device. A server database module replaces partition content on a user's webpage if the server content has been flagged for update for the particular user. For example, in specific embodiments, server content is text describing the game play or a graphic of a game card. In certain game play embodiments, server content is constantly updated by a database server module using, for example, input data from a user. In further or additional embodiments, server content comprises data reflecting the most current state of an online game.

### Online Card Engine: Pulsing of Partition Content

Another feature of the platforms, methods, products, devices and systems described herein is a pulsed online gaming engine. The pulse process is utilized to update at least a portion of a user's website or display page. The pulsing from a database server to a display of each player within a game play network causes the display of the users to update with updated game information (e.g., a player move or change in a user's partition content) provided from a server database module. The purpose of the pulsing is to reflect changes in game play by other users within the network. The pulse process then enables, in one embodiment, an enhanced online gaming experience comprising users that view moves by players of the online game in real time, or close to real time. For example, in certain embodiments, the pulse process is a timed function that is sent to each player's web browser when the player first joins a game, updates the screen, or is passively or actively playing a game. Thus, the pulsing allows game play users to view other player's moves and inputs at about the same time the move or input is made. Once pulsed, a server database module then determines whether any partition content is in need of updating by determining whether the corresponding server content for that user is flagged for update.

Provided herein is a method for updating a content displayed to a user of a gaming network without requiring refreshing of the user's display page that comprises the step of updating a partition content that is depicted on a display page of a user of a gaming network with a corresponding server content if the corresponding server content is flagged for update. In some embodiments, the network is the internet, the display page is a webpage, and/or a server content is unflagged for a particular user after it is updated on a webpage of the internet for that particular user. In further or additional embodiments, the method further comprises the step of flagging the server content for update for at least one user in response to any change in the server content. In a specific embodiment, the change in the server content is initiated by a user of the website. In another or further embodiment, the change in the server content is initiated by an automated function. In some embodiments, the server content is flagged for a user of a website. In further or additional embodiments, the server content is flagged for no user of a website. In some embodiments, the updating function is scheduled. In still further embodiments, the updating function is scheduled to occur every two seconds. In further or additional embodiments, web content appears on a plurality of windows. In a specific embodiment, web content appears on a pop-up window that can be opened, moved, and closed by a user of the website. In yet further or additional embodiments, the content is related to an online web-based game that is selected from a card game, a board game, a casino game, a cell phone game, a dice game, an arcade game, a puzzle game, a role playing game, a tabletop game, or a video game.

Also provided herein is a method for updating a content displayed simultaneously to at least a first user and a second user of a gaming network without requiring refreshing of a display page that comprises the step of updating a partition content that is depicted on a display page of the first user of a gaming network with a corresponding server content for the first user if the corresponding server content is flagged for update for the first user. In some embodiments, the network is the internet, the display page is a webpage, and the method further comprises the step of unflagging the server content for the first user after it is updated on a webpage of the first user. In further or additional embodiments, the method further comprises the step of flagging the server content for update for all users in response to any change in the server content. In some embodiments, the method further comprises a change in the server content once initiated by the first user. In further or additional embodiments, the method further comprises a change in the server content that is initiated by the first user and the second user. In some embodiments, a change in the server content is initiated by an automated function. In yet further or additional embodiments, a server content is flagged for no users. In some embodiments, a server content is flagged for the first user but not the second user. In further or additional embodiments, a server content is flagged for the first user and the second user. In some embodiments, the updating function is scheduled. In a specific embodiment, the updating function is scheduled to occur every two seconds. In further or additional embodiments, the updating function for the first user but not the second user. In certain embodiments, the method simultaneously performs the updating function for the first user and the second user. In some embodiments, the web content appears on a plurality of windows to the first user. In still further embodiments, the web content appears on a pop-up window that can be opened, moved, and/or closed by the first user. In a specific embodiment, the content is related to an online web-based game that is selected from a card game, a board game, a casino game, a cell phone game, a dice game, an arcade game, a puzzle game, a role playing game, a tabletop game, or a video game.

Also described herein are platforms, products, devices and systems. In some embodiments, provided are such apparatuses for updating content displayed to a user of a gaming network without requiring refreshing of a webpage comprising:

(a) a digital processing device that is connected to a network comprising an operating system configured to perform executable instructions and which comprises a memory device, a display, and an input device; and

(b) content provided to the digital processing device via the network wherein the executable instructions are configured to:
transmit a server content flagged for update to a display page; and
replace a corresponding partition content on the display page with the server content without requiring refreshing the webpage.

In some embodiments, the network is the Internet, the display page is a webpage, and/or the apparatus is further configured to un-flag the server content for update after it is updated on the webpage. In further or additional embodiments, provided is a configuration to flag the server content for update in response to any change in the server content. In some embodiments, the change in the server content is initiated by a user of the website. In further or additional embodiments, provided is server content that is initiated by an automated function. In a specific embodiment, the server content is flagged for a user of the display page. In yet further or additional embodiments, the server content is flagged for no user of the display page. In some embodiments, the transmission function is scheduled. In yet further or additional embodiments, the transmission function is scheduled to occur every two seconds. In one embodiment, the web content appears on a plurality of windows. In further or additional embodiments, web content appears on a pop-up window that can be opened, moved, and closed by a user of the display page. In certain embodiments, the content is related to an online web-based game that is selected from a card game, a board game, a casino game, a cell phone game, a dice game, an arcade game, a puzzle game, a role playing game, a tabletop game, or a video game.

In some embodiments of the platforms, products, devices and systems described herein, provided are apparatuses for updating web content displayed simultaneously to at least a first user and a second user of a gaming network without requiring refreshing of a webpage comprising:

(a) a digital processing device that is connected to a network comprising an operating system configured to perform executable instructions and which comprises a memory device, a display, and an input device; and

(b) content provided to the digital processing device via the network wherein the executable instructions are configured to:
transmit a server content to a display page of the first user when the server content is flagged for update by the second user; and
replace a corresponding partition content on the display page of the first user with the server content without requiring refreshing the webpage.

In some embodiments, the network is the Internet, the display page is a webpage, and/or the apparatus (including the platforms, products, devices and systems) is further configured to un-flag the server content for update for the first user after it is updated on the webpage or display page of the first user. In particular embodiments, the apparatuses described herein are further configured to flag the server content for update for all users in response to any change in the server content. In further or additional embodiments, a change in the server content is initiated by the first user but not the second user. In still further or additional embodiments, the change in the server content is initiated by the first user and the second user. In further or additional embodiments, the server content is initiated by an automated function. In some embodiments, the server content is flagged for no user of the website. In a specific embodiment, the server content is flagged for the first user but not the second user. In some embodiments, the server content is flagged for the first user and the second user. In some embodiments, the transmission function is scheduled. In still further embodiments, the transmission function is scheduled to occur every two seconds. In yet further embodiments, the transmission function for the first user but not the second user. In additional or further embodiments, the apparatuses disclosed herein simultaneously perform a transmission function for the first user and the second user. In yet additional embodiments, the web content appears on a plurality of windows to the first user. In some embodiments, the web content appears on a pop-up window that can be opened, moved, and closed by the first user. In yet additional embodiments, the content is related to an online web-based game that is selected from a card game, a board game, a casino game, a cell phone game, a dice game, an arcade game, a puzzle game, a role playing game, a tabletop game, or a video game.

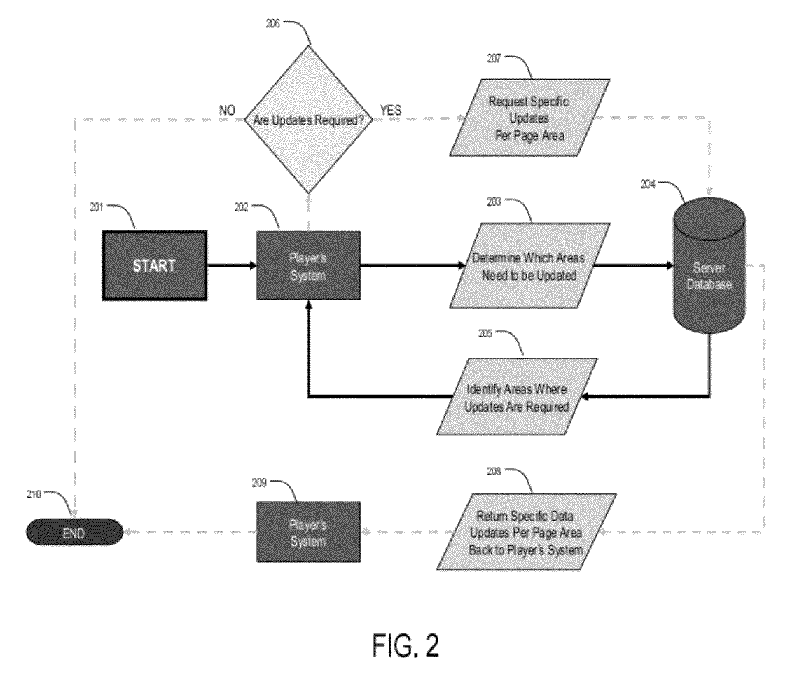

Referring to FIG. 2, shown is an online card engine for a web-based gaming network depicting one embodiment of a server database pulsing a user's webpage. A server database module 204 provides a “flag” assigned to server content for each user of the web-based network. In some embodiments, an online game player initiates a game play move or other input 201 for example with the input of data or content on a webpage 202. The action taken by the inputting user changes at least one partition content of the inputting user's webpage. In some embodiments, a server database module 204 then un-flags all server content that corresponds to the partition content for the inputting user; all other flag(s) for server content of the inputting user (including flags for other partition content displayed on the inputting user's website) and all other flag(s) for server content of other users remain in place. In further or additional embodiments, after input of data by a user (e.g., a player), all server content that corresponds to the inputting user's webpage is un-flagged for that user; all other flag(s) for server content of other users remain in place.

The player's display is configured to determine if any update is necessary by sending a pulse 206 to a database server module. In some embodiments, the pulse request to a database server module 204 is made about every 2 seconds. In further or additional embodiments, the pulsing occurs once per about a tenth of a second to about 5 seconds. In some embodiments, the pulsing occurs once per about a fifth of a second to about 4 seconds. In further or additional embodiments, the pulsing occurs once per about a half second to about 3 seconds. In yet further embodiments, the pulsing occurs once per about 1 to about 2 seconds.

If an update is not required (for example because no corresponding flagged server content for that user when pulsed), then no change in partition content is made for that user. Alternatively, if when pulsed, the server database module indicates server content is flagged for the user, then the server database module proceeds to identify and determine the partition content to update for the flagged user.

Next, as shown in the non-limiting example of FIG. 2, a server database module (either the same or different module) identifies and determines which areas (i.e., partition content) of the flagged user(s) webpage is in need of update 203 and 205. A server database module (either the same or different module) then updates 208 the partition content with server content for the flagged user(s) 209.

In certain embodiments, after partition content for a particular user has been updated with server content, the corresponding server content becomes un-flagged for that user. As such, the partition content is not updated again until it receives the next pulse for that user with the server content flagged for the user. In specific embodiments, the flagging and unflagging process of server content by the database server module is repeated during the period of game play.

### Online Card Engine: Player Action

Yet another feature of the platforms, methods, products, devices, and systems described herein is an online card engine for a web-based gaming network comprising the transmission of data from a player's display to a server database module.

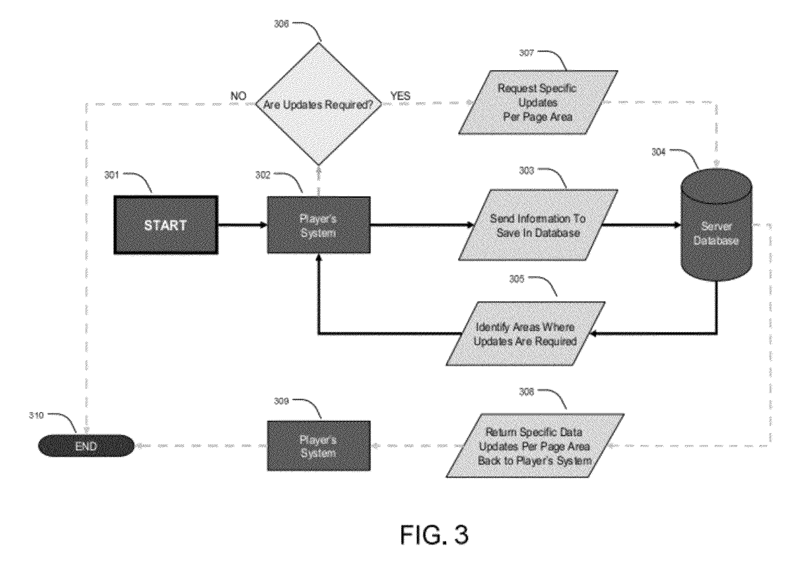

Referring to FIG. 3, when a player initiates a game play or other input 301 that changes a partition content of a player's system 302, data representing the play or input is transmitted 303 to a server database module 304 and saved as server content for the gaming network in the server database module. The remaining non-limiting aspects and functionality depicted in FIGS. 3 of 305, 306, 307, 308 and 309 correspond to the aspects and functionality of 205, 206, 207, 208, and 209, respectively, as described with respect to FIG. 2 herein.

### Online Card Engine: Player Creation of a Card Game

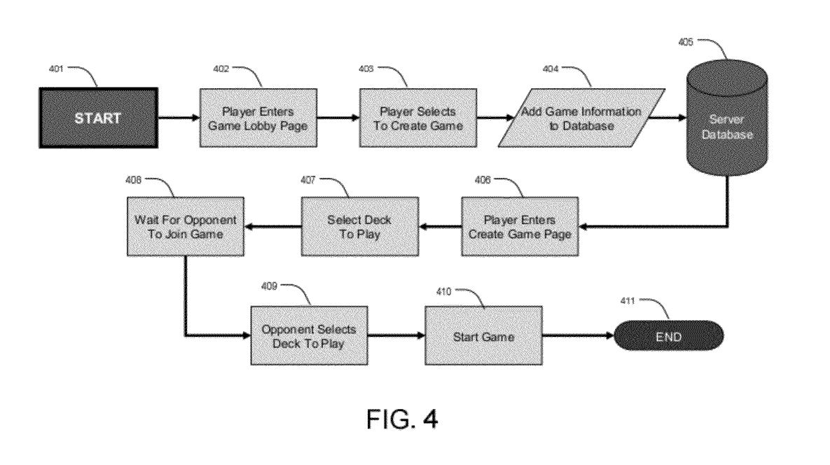

Yet another feature of the platforms, methods, products, devices, and systems described herein is an online card engine for a web-based gaming network comprising a user initiation of an online game. Referring to non-limiting example depicted in FIG. 4, in some embodiments a player 401 arrives at a host website and navigates to a game page supported by an online card engine. The player then enters an online game lobby page 402. The player then has the option and initiates the selection of a creation of a game 403. Optionally, the player inputs data about a specific game or games 404 to the server database module 405. Once in the lobby, the player then has the option to chat with other players (not shown), join an existing game (not shown), or create their own game 406. If a player joins an existing game then they will be presented with a pop up window to select which deck they want to play, a game chat window to talk with an opponent (not shown), a leave game button (not shown), and a ready button (also not shown). After selecting a ready button, the player simply waits for the game creator to start the game.

In situations where a player chooses to create a new game, the player is presented a pop up window allowing the player to rename the room, select their deck 407, delete the game, remove a player out of the game, or start the game. Once an opponent joins the game 408, selects its deck to play 409, and is ready, the game is started 410.

### Optional Features

The gaming platforms, systems, methods, products, and devices described herein comprise a computer program executable by a digital processing system that creates the gaming platforms described herein.

The computer program includes a sequence of instructions, executable in the digital processing device's CPU, written to perform a specified task. Those of skill in the art will recognize that the computer program may be written in various versions of various languages. The computer program may be written in one or more markup languages, style languages, client-side scripting languages, server-side coding languages, or combinations thereof. In some embodiments, the computer program is written to some extent in a markup language such as Hypertext Markup Language (HTML), Extensible Hypertext Markup Language (XHTML), or eXtensible Markup Language (XML). In some embodiments, the computer program is written to some extent in a style language such as Cascading Style Sheets (CSS). In some embodiments, the computer program is written to some extent in a client-side scripting language such as Asynchronous Javascript and XML (AJAX), Flas^{h}®, Actionscript, Javascript, or Silverligh^{t}®. In some embodiments, the computer program is written to some extent in a server-side coding language such as Active Server Pages (ASP), ColdFusioⁿ®, Common Gateway Interface (CGI), Perl, Java™, Hypertext Preprocessor (PHP), Python™, Ruby, Structured Query Language (SQL), mySQL™, Oracl^{c}®, or .NET.

The gaming methods, platforms, devices, systems, and products described herein comprise software, server, and database modules. In view of the disclosure provided herein, these modules are created by techniques known to those of skill in the art using machines, software, and languages known to the art. In some embodiments, the modules are in a single computer program. In other embodiments, the modules are in more than one computer program. In some embodiments, the modules are hosted on one machine. In other embodiments, the modules are hosted on more than one machine. In some embodiments, the modules are hosted on one or more machines in one location. In other embodiments, the modules are hosted on one or more machines in more than one location. Further described herein is the formatting of data. The data files described herein are formatted in a data serialization format known to those in the art including, by way of non-limiting examples, tab-separated values, comma-separated values, character-separated values, delimiter-separated values, XML, JSON, BSON, and YAML.

The digital processing device includes an operating system configured to perform executable instructions. The operating system is, for example, software, including programs and data, which manages the device's hardware and provides services for execution of applications. Those of skill in the art will recognize that suitable personal computer operating systems include, by way of non-limiting examples, Microsoft® Windows®, Apple® Mac OS X®, UNIX®, and UNIX-like operating systems such as GNU/Linux®.

The digital processing device includes a memory device. The memory is one or more physical apparatus used to store data or programs on a temporary or permanent basis. In some embodiments, the memory is volatile and requires power to maintain stored information. In some embodiments, the memory is non-volatile and can retain stored information when the digital processing device is not powered.

The digital processing device includes a display to send visual information to a gamer. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is a plasma display. In other embodiments, the display is a video projector. In still further embodiments, the display is a combination of devices such as those disclosed herein.

The digital processing device optionally includes a sound output device to send auditory information to a gamer. In some embodiments, the sound output device is a pair of headphones, earphones, or ear buds. In some embodiments, the sound output device is an electro-acoustic transducer or loudspeaker. In further embodiments, the sound output device is a flat panel loudspeaker, a ribbon magnetic loudspeaker, or a bending wave loudspeaker. In other embodiments, the sound output device is a piezoelectric speaker. In still further embodiments, the sound output device is a combination of devices such as those disclosed herein.

The digital processing device includes an input device to receive information from the gamer. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

1.-28. (canceled)

29. A system for updating a partition content displayed to a user of a gaming network without requiring refreshing of a webpage comprising:
(a) a digital processing device that is connected to a network comprising an operating system configured to perform executable instructions and which comprises a memory device, a display, and an input device; and
(b) content provided to the digital processing device via the network wherein the executable instructions are configured to:
transmit a server content flagged for update to a display page; and
replace a corresponding partition content on the display page with the server content without refreshing the display page.

30. The system in claim 29 wherein network is the Internet, the display page is a webpage, and wherein the system is further configured to un-flag the server content for update after it is updated on the webpage.

31. The system in claim 29 that is further configured to flag the server content for update in response to any change in the server content.

32. The system of claim 31 wherein the change in the server content is initiated by a user of the website.

33. The system of claim 31 wherein the change in the server content is initiated by an automated function.

34. The system of claim 29 wherein the server content is flagged for a user of the display page.

35. The system of claim 29 wherein the server content is flagged for no user of the display page.

36. The system of claim 29 wherein the transmission function is scheduled.

37. The system of claim 29 wherein the transmission function is scheduled to occur every two seconds.

38. The system of claim 29 wherein the web content appears on a plurality of windows.

39. The system of claim 29 wherein the web content appears on a pop-up window that can be opened, moved, and closed by a user of the display page.

40. The system of claim 29 wherein the content is related to an online web-based game that is selected from a card game, a board game, a casino game, a cell phone game, a dice game, an arcade game, a puzzle game, a role playing game, a tabletop game, or a video game.

41. A system for updating a partition content displayed simultaneously to at least a first user and a second user of a gaming network comprising:
(a) a digital processing device that is connected to a network comprising an operating system configured to perform executable instructions and which comprises a memory device, a display, and an input device; and
(b) content provided to the digital processing device via the network wherein the executable instructions are configured to:
transmit a server content to a display page of the first user when the server content is flagged for update by the second user; and
replace a corresponding partition content on the display page of the first user with the server content without refreshing the display page of the first user.

42. The system in claim 41 wherein network is the Internet, the display page is a webpage, and wherein the system is further configured to un-flag the server content for update for the first user after it is updated on the webpage of the first user.

43. The system in claim 41 that is further configured to flag the server content for update for all users in response to any change in the server content.

44. The system of claim 43 wherein the change in the server content is initiated by the first user but not the second user.

45. The system of claim 43 wherein the change in the server content is initiated by the first user and the second user.

46. The system of claim 43 wherein the change in the server content is initiated by an automated function.

47. The system of claim 42 wherein the server content is flagged for no user of the website.

48. The system of claim 41 wherein the server content is flagged for the first user but not the second user.

49. The system of claim 41 wherein the server content is flagged for the first user and the second user.

50. The system of claim 41 wherein the transmission function is scheduled.

51. The system of claim 41 wherein the transmission function is scheduled to occur every two seconds.

52. The system of claim 41 that performs the transmission function for the first user but not the second user.

53. The system of claim 41 that simultaneously performs the transmission function for the first user and the second user.

54. The system of claim 41 where the web content appears on a plurality of windows to the first user.

55. The system of claim 42 where a web content appears on a pop-up window that can be opened, moved, and closed by the first user.

56. The system of claim 41 wherein the content is related to an online web-based game that is selected from a card game, a board game, a casino game, a cell phone game, a dice game, an arcade game, a puzzle game, a role playing game, a tabletop game, or a video game.
